(19) United States
(12) Patent Application Publication
(10) Pub. No.: US 2011/0299170 A1
(43) Pub. Date: Dec. 8, 2011

(54) ELECTRO-OPTIC REARVIEW MIRROR ELEMENT WITH FILL PORT FILTER AND METHOD OF MANUFACTURING ELECTRO-OPTIC REARVIEW MIRROR ELEMENT

(75) Inventors: Jeffrey D. Harlow, Holland, MI (US); Michael J. Baur, Holland, MI (US)

(73) Assignee: MAGNA MIRRORS OF AMERICA, INC., Holland, MI (US)

(21) Appl. No.: 13/099,554

(22) Filed: May 3, 2011

Related U.S. Application Data
(60) Provisional application No. 61/330,590, filed on May 3, 2010.

(51) Int. Cl. G02F 1/19; B23P 17/04; B60R 1/08

(52) U.S. Cl. 359/604; 29/428

(57) ABSTRACT

A variable reflectance rearview mirror reflective element assembly includes a front substrate having a first surface and a second surface, and a rear substrate having a third surface and a fourth surface, with the third surface having a conductive coating disposed thereat. A perimeter seal is disposed between and spaces apart the front and rear substrates and forms an interpane cavity therebetween. The perimeter seal has a gap between terminal ends thereof to provide a fill port for the mirror reflective element assembly when the front and rear substrates are mated together. A filter element is disposed at the fill port at least during a cavity filling process, and the filter element allows an electro-optic medium to flow therethrough during the cavity filling process and limits passage of debris, contaminants and/or particles to limit intrusion of debris, contaminants and/or particles into the interpane cavity during the cavity filling process.

### CROSS REFERENCE TO RELATED APPLICATION

The present application claims the filing benefit of U.S. provisional application Ser. No. 61/330,590, filed May 3, 2010, which is hereby incorporated herein by reference in its entirety.

### FIELD OF THE INVENTION

The present invention relates generally to reflective element assemblies for rearview mirrors of vehicles and, more particularly, to electro-optic or electrochromic reflective element assemblies and a method for manufacturing electro-optic or electrochromic reflective element assemblies.

### BACKGROUND OF THE INVENTION

Automotive electrochromic mirror reflective element cell assemblies typically include a front substrate and a rear substrate and an electrochromic medium sandwiched therebetween and contained within an interpane cavity. The substrates are shaped as desired by the automobile manufacturer for a particular mirror design or application. For example, an interior rearview mirror reflective element may have substrates that are generally oval or trapezoidal in shape and are formed to be approximately 20-26 cm long and 5-8 cm tall or wide. Exterior mirror reflective element assemblies are shaped differently and may have sharper radii at the corners and may be flat or convex or aspheric, depending on the particular application. The size of the substrates for the exterior reflective element assemblies may vary from about 7 cm by 7 cm to about 10 cm by 18 cm or larger.

During manufacture and assembly of the reflective cell element assembly, the respective front and rear substrates are often cut or broken out as cut shapes from larger flat or curved lites, typically glass sheets or lites. The individual front and rear cut shapes or substrates are cleaned and then coated with a conductive or semiconductive coating or coatings that are reflective or transparent. After they are coated, an uncured adhesive material, typically an uncured epoxy material (often containing spacer beads, such as glass beads or the like), is applied around the perimeter of one of the cut shapes or substrates, and the other cut shape or substrate is superimposed thereupon and spaced apart from the first cut shape by the applied perimeter material. The uncured adhesive material is then cured, such as by heating, to adhere the shapes or substrates together and to space the substrates apart a desired or appropriate or selected amount to define an appropriate interpane cavity spacing. The substrates, so adhered together and interspaced apart, form an empty cell with an interpane cavity between the substrates and bounded by the perimeter seal.

Next, an electrolyte or monomer composition is filled into the cavity via an aperture (commonly known as a fill port or plug hole) provided in the perimeter material or seal, such as via a vacuum fill process. However, prior to or during the fill process, dirt or glass chips or dust or skin flakes or other debris or contaminants or the like may fall into or otherwise be disposed at or become lodged in the fill port and/or interpane cavity. Such debris or contaminants may be drawn into the cell through the fill port during the, vacuum fill process and may be visible in the finished reflective element and thus may result in a flawed cell exhibiting cosmetic defects (such as bright spots or contamination or the like, such as due to debris inside the cell, but not under the metal reflector coating or the transparent conductive coating) that may be discarded or scrapped.

For example, debris that may enter the cell through the fill port during the filling process may include or arise from dried flakes of the electro-optic composition or medium on the fill racks and/or fill rack rollers, dust or debris on the cells from handling or airborne particulate from the likes of unbagging, conductive epoxy, main seal bake, re-used bags, re-used cleanroom paper interleave in the vacuum bags, dirty oven trays, clothing lint, paper fibers and/or the like, and/or dust or debris in the bottles that contain the electro-optic composition or medium. The debris intrusion, such as through the fill port during the filling process may be evidenced by the defect not being visible from the rear of the cell, and in some situations the contaminants may move when the cell is compressed, indicating that they are free to move in the electro-optic composition or medium prior to polymerization thereof.

Therefore, there is a need in the art for an improved process for manufacturing electro-optic mirror reflective element assemblies, such as electrochromic mirror reflective element assemblies, that overcomes the shortcomings of the prior art.

### SUMMARY OF THE INVENTION

The present invention provides a method of making automotive electrochromic reflective cell element assemblies for automotive rearview mirror assemblies by providing a filter element or means at the fill port of the reflective element cell, whereby the filter means limits contaminant intrusion into the cell during the filling process. The formed electrochromic mirror cells are shaped for utilization in a complete automotive electrochromic rearview mirror assembly, such as the types described in U.S. Pat. Nos. 6,595,649; 6,648,477; 6,154,306; 5,610,756; 5,406,414; and/or 5,253,109, which are hereby incorporated herein by reference in their entireties. Optionally, aspects of the present invention may be suitable for application to other devices or cells with filled interpane cavities, such as, for example, display elements or devices (such as liquid crystal display devices) and/or the like.

According to an aspect of the present invention, a variable reflectance vehicular electro-optic rearview mirror reflective element assembly comprises a front substrate having a first surface that generally faces a driver of a vehicle equipped with a mirror assembly that incorporates the rearview mirror reflective element assembly, and having a second surface opposite the first surface, with the second surface of the front substrate having a transparent electrically conductive coating disposed thereat. The reflective element assembly comprises a rear substrate having a third surface and a fourth surface, with the third surface having a conductive coating disposed thereat. A perimeter seal is disposed between the front and rear substrates and spaces the front and rear substrates apart and forms or establishes an interpane cavity therebetween. The perimeter seal has a gap between terminal ends of the perimeter seal to provide a fill port for the mirror reflective element assembly when the front and rear substrates are mated together. A filter element is disposed at the fill port, and allows an electro-optic medium to flow therethrough during a cavity filling process and limits passage of debris and/or contaminants to limit intrusion of debris and/or contaminants into the interpane cavity during the cavity filling process.

According to another aspect of the present invention, a method of manufacturing a variable reflectance vehicular electro-optic rearview mirror reflective element assembly includes providing a front substrate having a first surface that generally faces a driver of a vehicle equipped with a mirror assembly that incorporates the rearview mirror reflective element assembly. The front substrate has a second surface opposite the first surface and the second surface of the front substrate has a transparent electrically conductive coating disposed thereat. A rear substrate is provided that has a third surface and a fourth surface, with the third surface having a conductive coating disposed thereat. A perimeter seal is dispensed at a perimeter edge region of one of the front and rear substrates, wherein the perimeter seal has a gap between terminal ends of the perimeter seal. The front and rear substrates are mated together, whereby the perimeter seal spaces the front and rear substrates apart and forms an interpane cavity therebetween. The gap between the terminal ends of the perimeter seal provides or establishes a fill port for the mirror reflective element assembly when the front and rear substrates are mated together. A filter element is provided at the fill port, and the interpane cavity is filled with an electro-optic medium that flows into the interpane cavity through the fill port and through the filter element. The filter element allows the electro-optic medium to flow therethrough during the cavity filling process and limits passage of debris and/or contaminants to limit intrusion of debris and/or contaminants into the interpane cavity during the cavity filling process. The fill port is plugged to substantially seal the electro-optic medium in the interpane cavity.

Optionally, the filter element may comprise a filter element that is provided at the fill port before mating the front and rear substrates together, whereby the filter element is disposed at the gap and between the perimeter seal and one of the front and rear substrates. Optionally, the filter element may be provided at the fill port after mating the front and rear substrates together. Optionally, the filter element may be removably attached (such as via adhesive tape or the like) at the substrates and at least partially over the fill port. The method may comprise removing the filter element after the cavity filling process and before plugging the fill port. Optionally, the filter element may comprise a mesh material.

The filtering means may comprise any suitable material or elements that function to limit passage of debris or the like in the fluid that is being filled into the interpane cavity. Optionally, the filtering means may be integral with the cell or reflective element assembly or may be removably disposed at the fill port or attached to the cell at the fill port, or may be included in the fluid that is being filled into the interpane cavity. For example, a plurality of elements that are larger than the fill port dimensions (with a typical fill port having a width of around 0.5 mm to around 1 mm or thereabouts (or more or less) and a height of around 80 microns to around 250 microns or thereabouts (or more or less)), such as balls or elements having a diameter of around 300 microns (or more or less, but having a diameter or dimension that is greater than the larger cross dimension of the fill port so that the filter elements cannot pass through the fill port during the filling process), may be disposed in the fluid, whereby the balls in the fluid may congregate at the fill port to form a living mesh or gauze at the fill port entry to limit passage of debris or the like through the fill port into the interpane cavity, while allowing for passage of the fluid through the living mesh and through the fill port and into the interpane cavity during the filling process.

Therefore, the present invention provides a means for filtering the flow of the electro-optic medium liquid during the cell-filling process to limit intrusion of debris and/or contaminants into the cell interpane cavity during the fill process. The filtering element or means may comprise any suitable element or material (either at the fill port or cell or in the fluid itself) that functions to allow the liquid electro-optic medium composition to flow through the fill port into the interpane cavity (such as via a vacuum filling process or the like), while limiting flow of debris and/or contaminants through the fill port and thus limiting intrusion of debris and/or contaminants into the cell interpane cavity during the filling process. The present invention thus provides an enhanced method of manufacturing an electro-optic mirror element or cell that may result in reduced cosmetic defects in the completed and filled cell and thus that may result in reduced scrap rate of completed and filled cells.

These and other objects, advantages, purposes and features of the present invention will become apparent upon review of the following specification in conjunction with the drawings.

### BRIEF DESCRIPTION OF THE DRAWINGS

FIG. 1 is a plan view of a reflective element assembly with a filter element at the fill port of the reflective element assembly in accordance with the present invention;

FIG. 2 is a side elevation of the reflective element assembly of FIG. 1;

FIGS. 3-5 are images of reflective element assemblies with filter elements at the fill ports of the reflective element assemblies in accordance with the present invention;

FIG. 6 is a sectional view of a fill port region of a reflective element assembly with a filter element in accordance with the present invention;

FIG. 7 is a sectional view of a fill port region of another reflective element assembly with a double layer of filter elements in accordance with the present invention;

FIG. 8 is a sectional view of a fill port region of another reflective element assembly with another filter element in accordance with the present invention; and

FIG. 9 is a schematic of another filter element for use at a fill port of a reflective element assembly in accordance with the present invention.

### DESCRIPTION OF THE PREFERRED EMBODIMENTS

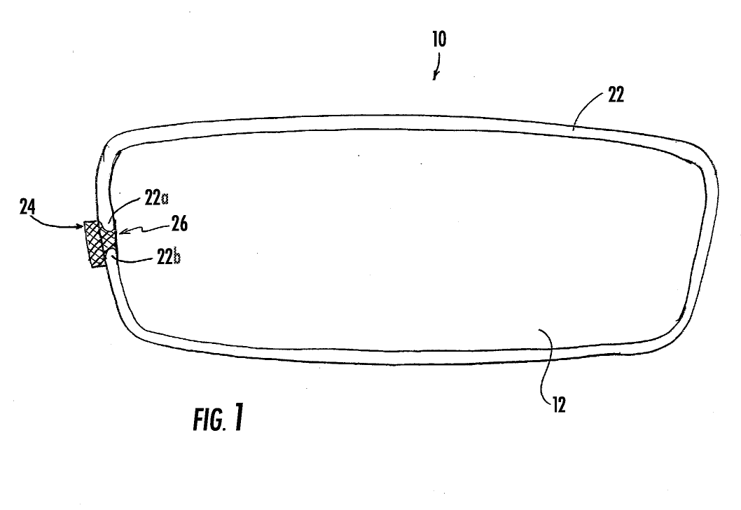

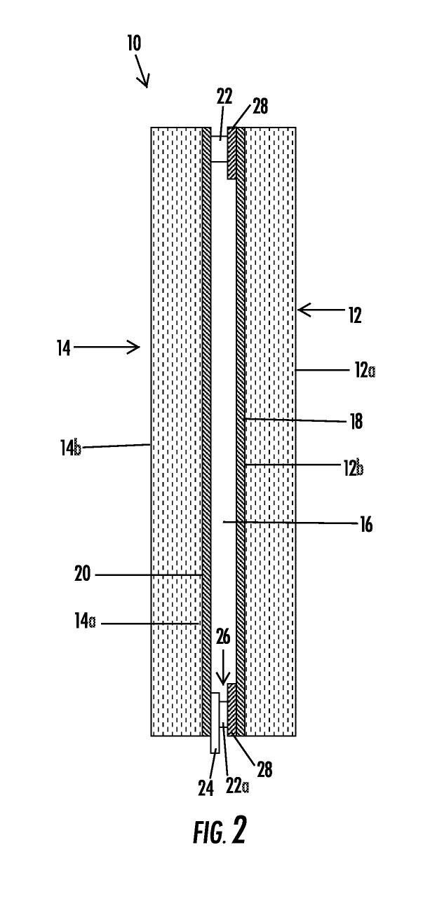

Referring now to the drawings and the illustrative embodiments depicted therein, an electro-optic mirror reflective element assembly or cell 10 (such as an electrochromic mirror reflective element or cell) for an interior or exterior rearview mirror assembly of a vehicle includes a first or front substrate or glass element 12 and a second or rear substrate or glass element 14 (FIGS. 1 and 2). The rear reflective element substrate 14 is spaced from front reflective element substrate 12, and the cell includes an electro-optic medium 16, such as an electrolyte or monomer composition or electrochromic medium or the like, sandwiched between the substrates 12, 14 and in contact with conductive or semi-conductive layers 18, 20 (described below) established at the cavity facing surfaces 12b, 14a of the front and rear substrates 12, 14, respectively. A perimeter seal 22 (such as an epoxy seal material or the like) is applied between the substrates to establish the cavity for the electrochromic medium and to adhere the substrates together. A filter element or filtering means 24 is disposed at or established at the fill port 26 of the reflective element assembly 10 to limit or substantially preclude contaminant intrusion into the fill port and/or interpane cavity during the filling process that fills the cavity with the electro-optic medium 16, as discussed below.

As shown in FIG. 2, the reflective element assembly or cell 10 includes front substrate 12 and rear substrate 14, with the electro-optic medium 16 (such as an electrochromic medium) disposed therebetween (and sealed or contained within the interpane cavity between the glass substrates 12, 14 via the perimeter seal 22). The front substrate 12 has a front or first surface 12a (that faces generally towards a driver of a vehicle when the mirror assembly is normally mounted in the vehicle) and a rear or second surface 12b, with a transparent conductive coating 18 (such as an indium tin oxide (ITO) coating or the like) established at second surface 12b, while the rear substrate 14 has a front or third surface 14a (facing the interpane cavity and electro-optic medium disposed between the front and rear substrates) and a rear or fourth surface 14b, with a metallic reflector coating 20 (such as a transflective display-on-demand reflector coating that is partially transmissive of light therethrough and partially reflective of light incident thereon) established at third surface 14a.

The rear or second surface 12b of front substrate 12 may include one or more transparent electrically conductive layers. (such as an indium tin oxide (ITO) layer, or a doped indium tin oxide layer or any other transparent electrically semi-conductive layer or coating or the like (such as indium cerium oxide (ICO), indium tungsten oxide (IWO), or indium oxide (JO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat, No. 7,274,501, which is hereby incorporated herein by reference in its entirety) thereat. The coated rear surface 12b defines the active EC area 12c of the front substrate within the perimeter seal 22. The front or third surface 14a may include one or more transparent semi-conductive layers (such as an ITO layer or the like), and/or one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The reflective element assembly 10 thus may comprise a third surface transflective element assembly or cell, whereby the reflective layer or surface is disposed at the third surface of the cell or at the front surface of the rear reflective element substrate for viewing by a driver of the vehicle. The third surface 14a defines the active EC area or surface of the rear substrate within the perimeter seal 22. The coated third surface 14a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers 20 to an electrical clip of connector or bus-bar, such as the types described in U.S. Pat. Nos. 5,066,112 and 6,449,082, which are hereby incorporated herein by reference in their entireties.

Optionally, the reflective element may include a metallic perimeter band 28 around the perimeter of the reflective element, such as by utilizing aspects of the reflective elements described in U.S. Pat. Nos. 7,626,749; 7,274,501; 7,184,190; and/or 7,255,451, and/or U.S. pat. application Ser. No. 11/226,628, filed Sep. 14, 2005 (Attorney Docket DON01 P-1236), which is hereby incorporated herein by reference in their entireties. Optionally, the perimeter band may comprise a chrome/chromium coating or metallic coating and may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, the mirror reflective element may comprise a frameless reflective element (such as a frameless exterior mirror assembly or a frameless interior mirror assembly), such as by utilizing aspects of the reflective elements described in U.S. Pat. Nos. 7,626,749; 7,360,932; 7,289,037; 7,255,451; 7,274,501; and/or 7,184,190, and/or PCT Application No. PCT/US2010/32017, filed Apr. 22, 2010; and/or U.S. patent applications, Ser. No. 11/226,628, filed Sep. 14, 2005 (Attorney Docket DON01 P-1236); and/or Ser. No. 10/538,724, filed Jun. 13, 2005 (Attorney Docket DON01 P-1123); and/or U.S. provisional applications, Ser. No. 61/249,300, filed Oct. 7, 2009; and/or Ser. No. 61/261,839, filed Nov. 17, 2009, which are hereby incorporated herein by reference in their entireties.

As is known in the art, the perimeter seal material 22 is established around the periphery of one of the substrates 12, 14, such as around the periphery of the rear substrate 14, and circumscribes the substrate surface (such as the front surface 14a of the rear substrate). The perimeter seal 22 may be dispensed with spacing elements 30 (such as glass beads or the like) that establish and maintain the desired or appropriate gap between the substrates 12, 14 when the substrates are mated together so that the interpane cavity has a generally or substantially uniform thickness or gap across the mirror reflective element assembly or cell 10. The perimeter seal 22 and spacing elements 30 are disposed or dispensed around the substrate surface and the seal material 22 has a gap 26 between opposed terminal ends 22a, 22b of the perimeter seal to establish the fill port for filling the interpane cavity with the electro-optic medium (such as via a vacuum fill process or the like).

In order to limit or retard or substantially preclude or prevent debris from entering the cell through the fill port (such as before or during the filling process), the present invention provides a fill port filter or fill port particle-ingress retarding element 24 or means for filtering at the fill port 26. Optionally, the filter 24 may be applied at the dispense and mate operation (when the perimeter seal material is dispensed on the substrate surface and the substrates are mated with one another), and would remain on the cell through fill and plug and plug cure (where a plug material is dispensed in the fill port after the fill process to seal the filled interpane cavity). There are many forms that this filter could take while remaining within the spirit and scope of the present invention. For example, the filter element or means may comprise a permanent filter, which is integral with or established partially in the mirror reflective element assembly and thus is part of the cell and is not removed after the cell is filled and the fill port is plugged, as discussed below, or the filter element or means may comprise a temporary filter that is established at or removably attached to the mirror reflective element or cell prior (and external to the cell and fill port and cavity) to the filling process and removed from the cell after the filling process is completed and prior to or at the time of plugging the fill port.

As is well known in the laminate electrochromic mirror art, an electrochromic mirror element or cell is formed by dispensing the uncured seal material around a periphery of one of the substrates while leaving a gap between opposed ends or portions of the seal material. The gap is formed/included to establish the fill port when the substrates are adhered together by the seal material and when the seal material is cured. The gap dimension or width dimension (the distance between the opposed ends or portions of the seal material) is selected to be larger than what may be necessary for filling the cell with the electro-optic material. During the cell manufacturing process, the substrates are brought together to sandwich the uncured seal material, and while the interpane distance is ultimately established by the likes of rigid glass or plastic beads, the uncured seal material may tend to be squeezed between the substrates so that the gap or fill port dimension in the uncured adhesive state is occluded or partially closed or even closed due to normal squeeze-out of the adhesive during the likes of vacuum bagging or mechanically-assisted pressing or lamination of the one substrate relative to the other substrate. For this reason, an uncured cell gap dimension (between the opposed ends or portions of the seal material) of around 1 mm or thereabouts is not uncommon. A cell gap dimension of, for example, 0.1 mm, would be difficult to maintain and/or control in volume production due to the aforementioned squeeze-out. The larger width or gap dimension thus is provided or established to avoid or substantially preclude gap or port closure during the seal material dispensing process and/or the substrate adhering process and/or seal curing process.

Thus, the fill port of the mirror cell is typically larger than it needs to be for filling of the cell cavity during the vacuum filling process. For example, the interpane distance of a typical mirror cell (or separation distance between the adhered glass substrates) is typically between about 50 microns and about 300 microns, more typically between about 80 microns and about 250 microns, and often between about 100 microns and about 200 microns, while the gap width or seal gap dimension (the dimension between the opposed ends or portions of the seal material) may be around 0.5 mm to around 1 mm or thereabouts (or more or less). Thus, there is a possibility that larger particles (that may be large enough to visibly affect the cosmetic appearance of the completed mirror cell yet small enough to fit through the gap or fill port) may ingress into the interpane cavity during the fill process. Thus, a particle or debris or contaminant (such as, for example, a particle having a diameter or width dimension of about 100 microns or thereabouts) may ingress into the cell (having a fill port that, for example, is about 150 microns by about 0.5 mm or thereabouts) during the vacuum filling process, and may be carried along, such as by the fluid material that is being ingressed into the interpane cavity. The present invention limits or substantially precludes such ingress of particles or contaminants or debris into the mirror cell during the vacuum filling process by establishing or providing a filter material or element or elements at or near or in the fill port and/or fluid that limit the size of particles that may enter the cell cavity during the filling process and thus that limits or retards or reduces or substantially precludes particle ingress into the interpane cavity during the fill process.

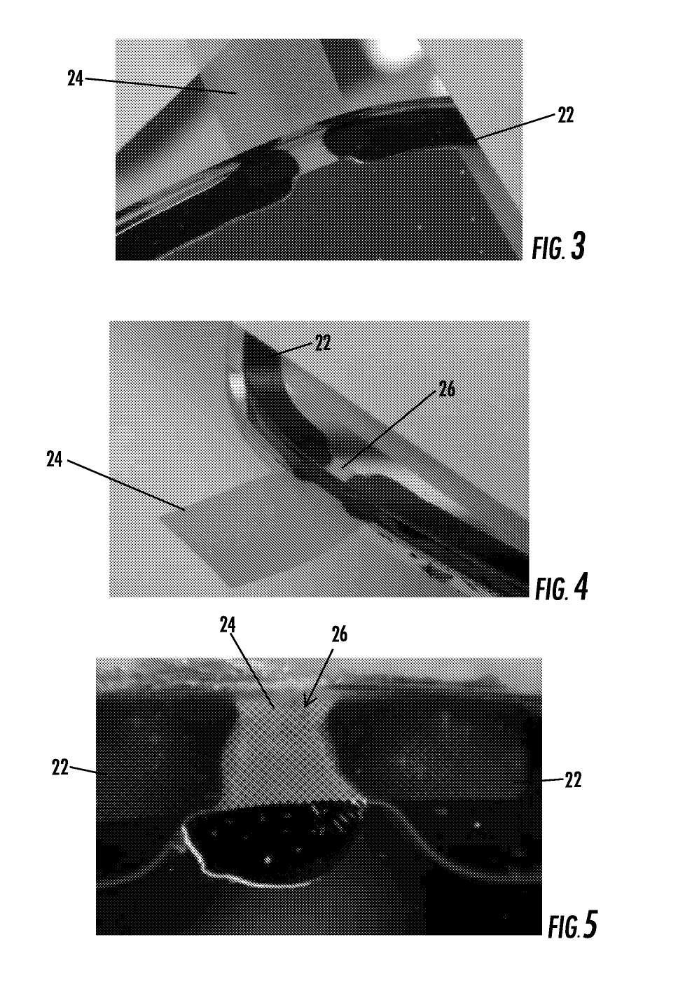

For example, and with reference to FIGS. 1 and 2, filter element 24 comprises a permanent filter element that is internal to or part of the completed reflective element assembly or cell. The filter element 24 is installed or established at least partially in the cell (such as at the fill port and at or beneath the epoxy seal, such as during the seal dispensing step or substrate mating step), whereby the filter element remains in the cell even after the filling process and fill port plugging process. In the illustrated embodiment, and as shown in FIGS. 3-5, the filter element 24 may comprise a mesh material that may be placed on the dispensed epoxy seal material immediately after it is dispensed on one of the substrates, and then, after placement of or positioning of the filter 24 at the fill port or gap in the seal material, the other part or substrate is mated on top of the filter and dispensed epoxy to form the mirror cell with the unfilled interpane cavity between the substrates.

In such an application (where the filter element is part of the mirror cell and is not removed after the filling process), the filter material is preferably selected according to the following criteria:
1. The filter material should not be electrically conductive;
2. The overall thickness of the filter material should be less than or equal to the cell gap or interpane cavity gap dimension;
3. The filter material should have sufficient open area or areas to allow for the flow of the electro-optic medium (such as a solid polymer matrix (SPM) material or the like) through the fill port during the vacuum fill process;
4. The filter material should have sufficient open area to allow for the flow of the plug material through the fill port during the plugging operation;
5. The filter material should be sufficiently transparent to allow for UV cure of the plug material;
6. The filter material should not react with or contaminate or dissolve in or substantially dissolve in the electro-optic fluid, because such reactions may cause adverse cosmetic effects; and
7. The temperature resistance of the filter material should be sufficient to withstand the main seal curing process, the conductive epoxy curing process, and the electro-optic medium curing process.
   An exemplary filter material for use as such a filter element is a polyester mesh product, such as the polyester mesh product that is commercially available from SaatiTech of Somers, N.Y., as product number PES45/29. Such a filter material has enhanced temperature and chemical resistance and thus is suitable for such mirror cell applications. In applications with such mesh filter material, it is desirable to cut the mesh material diagonally with respect to the thread structure (such as shown in FIG. 5) to limit or reduce or substantially preclude threads from separating from the filter element (such as may occur if the mesh material is cut parallel to the thread structure).

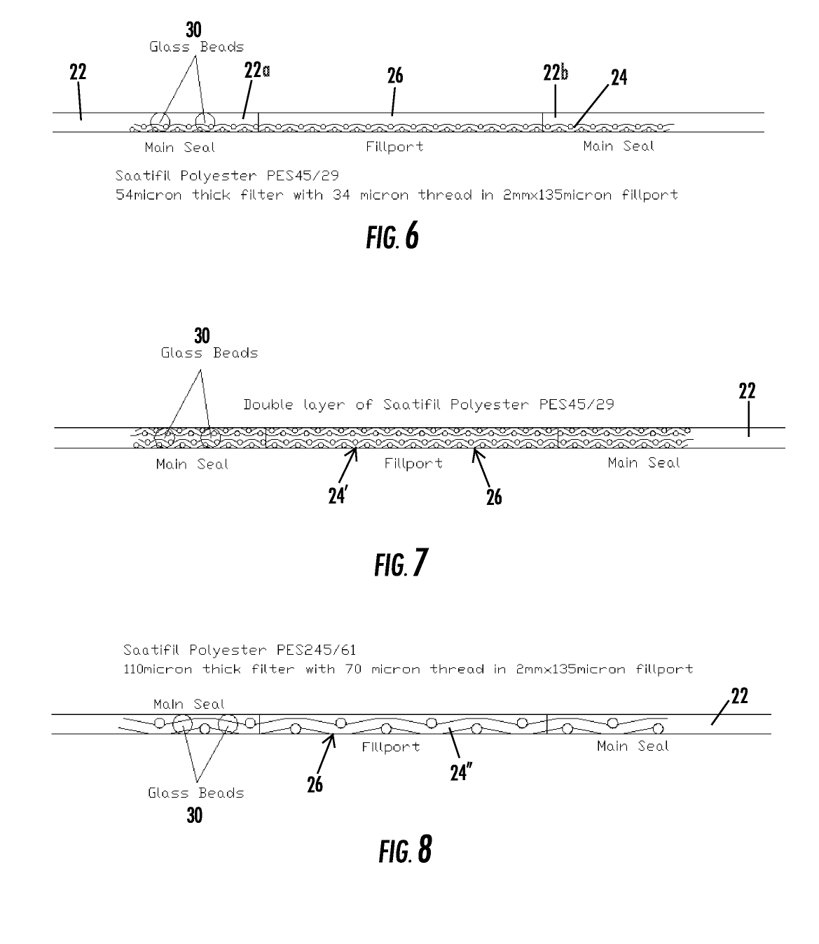

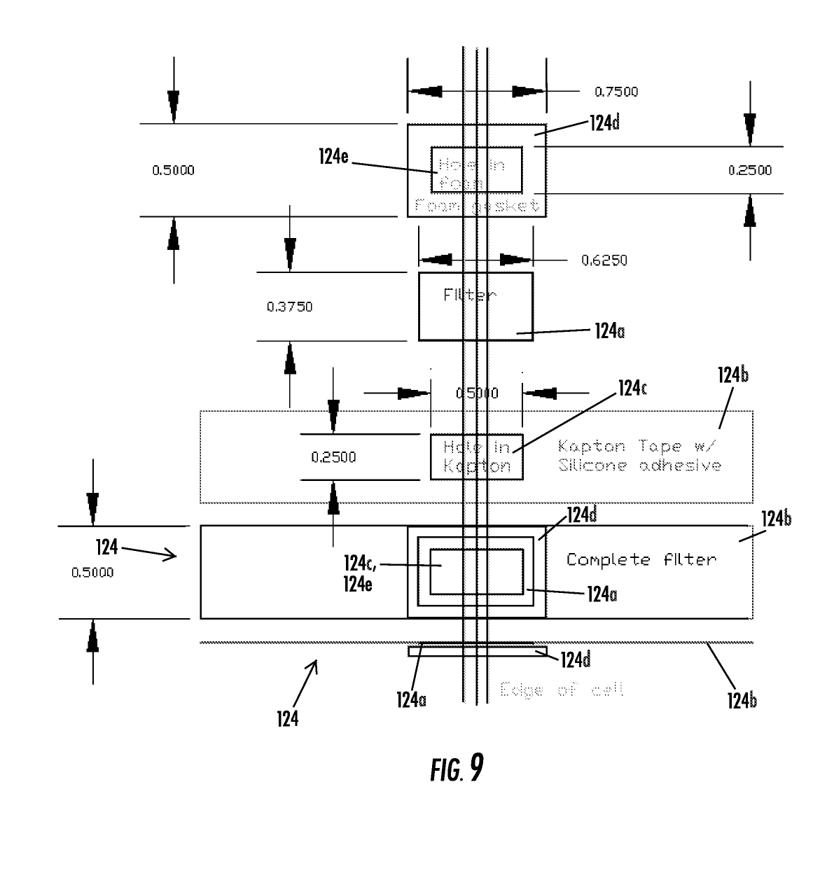

Optionally, the filter material may have a thickness dimension that does not fill the fill port gap. For example, and as shown in FIG. 6, the woven filter material of the filter element 24 (such as, for example, product PES45/29 or similar material) may have a thickness of only about 54 microns or thereabouts (or more or less) and may not span the gap between the substrates at the fill port. Optionally, and as shown in FIG. 7, the filter element 24′ may comprise a double layer of filter elements or mesh elements to substantially span the fill port opening or gap. Optionally, and as shown in FIG. 8, the filter element 24″ (such as, for example, product PES45/61 or PES 245/61 or similar material) may comprise a thicker mesh material (such as, for example, a material having a thickness of about 110 microns or thereabouts (or more or less) so as to substantially span and fill the gap between the substrates at the fill port.

In such mesh material applications, the selected filter material should be compliant enough to prevent double image near the fill port. This could be a concern with the double layer of filter material. Also, by providing a compliant filter material, the mesh filter material (such as polyester mesh filter material or the like) may conform or flex to the shape of the spacing elements or beads 30 (such as glass beads dispensed with the perimeter seal 24). For example, the glass beads (in the areas where the filter material overlaps the perimeter seal material at either side of the gap or fill port) tend to move to the opening in the mesh material and the threads of the mesh material may move or flex to accommodate the beads in such openings. This reduces the possibility of the filter and beads stacking on top of one another and increasing the gap dimension between the substrates at or near or around the fill port.

Various mesh sizes may be used for the filter element or material. For example, a mesh with larger openings between the woven threads may provide a greater opening or area for the glass beads to fill, and thus may reduce the risk for double image, but may also allow smaller particles or contaminants to pass through the filter and into the interpane cavity during the filling process. Also, a filter material that has thicker threads (such as filter element 24″ of FIG. 8) may better fill the gap or fill port and may better limit or substantially preclude debris or contaminant intrusion into the interpane cavity through the fill port during the filling process. Various mesh materials and mesh sizes (with different thread size or diameter and different sized spacings or gaps or holes in the mesh material) may be contemplated and implemented for a filtering means at the fill port of the electro-optic cell, while remaining within the spirit and scope of the present invention.

Other factors to consider in selecting a suitable or appropriate filter material include, for example, (a) the surface energy of the filter material, (b) the surface tension of the epoxy during the bake process, and (c) the thread geometry of the filter material. Such factors can have an effect on the performance of the fill port and filter and can affect the ability to maintain the fill port dimensions through the fill process. For example, the capillary action during the bake process may be increased with finer and denser thread geometry (such as may be achieved with a PES 45/29 material), which may result in a reduction in the size of the fill ports. Optionally, the fill port filter material may include a hydrophobic coating or hydrophilic coating or the like to reduce such capillary action and to enhance the filter performance.

Optionally, a larger thread geometry (such as may be achieved with a PES 245/61 material or the like, which has larger diameter threads and is a thicker mesh material) may provide enhanced capability to maintain the fill port dimensions through the bake process. However, care should be taken that the filter that is cut or formed (such as die cut or the like) from a larger thread material does not have individual threads falling off along the edge or edges of the die cut or otherwise formed filter (such thread fall off may result in the individual threads being within the interpane cavity and visible to a person viewing the reflective element when the reflective element is normally installed in a mirror assembly and the mirror assembly is normally mounted in a vehicle). Optionally, the filter may be formed via a heated die cut process in order to provide a seam at the filter's edge or edges to limit or substantially preclude individual thread fall off. Other forms of heating or otherwise processing or treating the cut or formed edge or edges of the filter may be implemented to reduce thread fall off so that the individual threads stay intact with the selected filter material,

The empty mirror cell may be filled via any suitable interpane cavity filling process or means, and may utilize aspects of the assemblies and systems described in U.S. Pat. No. 5,140,455, which is hereby incorporated herein by reference in its entirety. For example, mirror cells are typically filled via a vacuum backfill technique. In such a vacuum filling or backfilling process, the empty cell is placed in a vacuum chamber along with a container (typically a dish or small cup or the like) of the electro-optic medium fluid (such as electrochemichromic fluid or the like) intended to be filled through the single fill hole or port into the cell cavity. The chamber is evacuated to a high vacuum, such as 1 mm Hg or better. Means are then used to position the fill hole in the electro-optic medium fluid and under the surface of the electro-optic medium fluid. The chamber is then vented to atmospheric pressure (typically using nitrogen or similar inert gas or the like), and the atmospheric pressure forces the fluid into the cell cavity and so fills it with the electro-optic medium fluid. After the cell cavity is filled, the fill port is plugged or sealed, such as via a plugging process, where an epoxy or other suitable material (such as a suitable UV curable adhesive or the like) is established at and in the fill port and cured to seal the fill port and seal the fluid within the interpane cavity. It is envisioned that the filter element or mesh that remains in the fill port or gap may also function to reinforce the plug disposed thereat, such as in a similar manner as rebar in concrete, to substantially “lock” or secure the plug or plug material at the fill port.

After the reflective element is filled, the filter element 24 (which may protrude outwardly from the cell as shown in FIGS. 1-5) optionally may be trimmed along the exterior periphery of the reflective element assembly to complete the manufacturing or construction of the mirror reflective element or cell. Before or when or after the completed reflective element assembly is mounted at or received at a mirror casing or the like, electrical connectors may be conductively connected to the conductive coatings at the second surface of the front substrate and at the metallic reflector coating at the third surface of the rear substrate, whereby electrical power is selectively applied to the coatings via the connectors (and via the vehicle power source and dimming circuitry of the mirror assembly or vehicle) to vary the degree of dimming or darkening of the electro-optic medium of the mirror reflective element or cell. Optionally, the substrates may be adhered together after being cut to their mirror shape (such as shown in FIG. 1) or while in a larger sheet form with other substrates or mirror shapes, such as by utilizing aspects of the mirror assemblies described in U.S. Pat. No. 7,255,451, which is hereby incorporated herein by reference in its entirety.

Optionally, the filter element or filtering means may comprise a removable filter element that is disposed at the fill port prior to the fill process and is removed from the reflective element or cell after the fill process. Such a “Band-Aid” application has the filter element external to the cell. For example, and as shown in FIG. 9, an external filter element 124 may be applied as a tape at or after the dispense and mate processes (where the perimeter seal material is dispensed around the periphery of one of the substrates and the substrates are mated together).

In the illustrated embodiment, filter element 124 comprises a filter material 124a (such as a mesh material or the like that has openings therethrough, such as a plastic or polymeric mesh material or metallic mesh material or the like) to allow passage of the electro-optic medium material, yet functions to limit passage of debris or contaminants during the cell filling process. Filter element 124 may also include a tape element or attaching element 124b (such as a strip of Kapton tape or the like with a silicone adhesive or the like on a surface thereof) for attaching the filter element 124 to the cell and at the perimeter edge of the cell at or near the fill port. As shown in FIG. 9, tape element 124b has a hole or aperture 124c established therethrough, and the filter material 124a is attached at tape element 124b so as to cover aperture 124c of tape element 124b. Optionally, filter element 124 may include a foam gasket 124d or the like (with a hole or aperture 124e established therethrough) at and over the filter material 124a (with the aperture 124e of the gasket 124d generally aligning with the aperture 124c of the tape 124b). Such a foam gasket may be desired to enhance the seal between the filter element 124 and the edge of the cell so that the electro-optic medium fluid will pass through the filter material at the center of the gasket 124d.

After the mirror reflective element is assembled and prior to the filling process, the filter element 124 may be placed at the edge of the cell the tape may extend around the edge of the cell and may wrap around the edge of the cell to overlap the front or first surface and rear or fourth surface of the mirror cell to adhere the filter to the cell during the fill process. When so disposed, the filter material or mesh element 124a and the apertures of the gasket 124d and tape 124b are generally at and over the fill port of the cell. The cell may then be filled (such as via a vacuum filling process) and, after the filling process, the filter element 124 may be removed from the cell and the fill port may be plugged and sealed.

Although shown and described as being integral with the cell or removably attached to the cell prior to commencing the filling process, it is envisioned that other means for filtering the fluid at the fill port may be implemented to limit debris intrusion into the cell cavity during the filling process, while remaining within the spirit and scope of the present invention. Optionally, for example, the filtering means may be included in the fluid (such as an electrolyte or monomer composition or fluid) that is being filled into the interpane cavity. For example, a plurality of elements that are larger than the fill port dimensions (with a typical fill port having a width of around 0.5 mm to around 1 mm or thereabouts (or more or less) and a height of around 80 microns to around 250 microns or thereabouts (or more or less)), such as balls or elements having a diameter of around 300 microns (or more or less, but having a diameter or dimension that is greater than the larger cross dimension of the fill port so that the filter elements cannot pass through the fill port during the filling process), may be disposed in the fluid, whereby the balls in the fluid may congregate at the fill port during the filling process to form a living mesh or gauze at the fill port entry. The balls or elements thus may function to limit passage of debris or the like through the fill port into the interpane cavity, while allowing for passage of the electro-optic medium fluid composition through the living mesh and through the fill port and into the interpane cavity during the filling process. The balls or elements may comprise spherical balls that have a great enough diameter to limit passage into and through the fill port during the filling process and/or may comprise any other suitably shaped elements that have cross dimensions that are sufficient to limit passage of the elements into and through the fill port during the filling process and that engage one another in a manner that allows for fluid passage between and around the filtering elements while limiting or substantially precluding passage of debris or contaminants that may be present in the fluid and/or at the fill port. The balls or elements may comprise any suitable material, such as plastic or glass or metallic material, with the material selected so that the balls or elements disposed in the electro-optic medium fluid do not react with or contaminate or dissolve in the electro-optic fluid, and thus limit or substantially preclude causing adverse cosmetic effects to the completed filled and cured electro-optic mirror element or cell.

Therefore, the present invention provides a means for filtering the electro-optic medium material as it flows through the fill port of the mirror cell during the filling process. The method of making or forming the reflective element assemblies in accordance with the present invention includes providing a substrate and establishing or dispensing a perimeter seal material along the periphery of a surface of the substrate to substantially circumscribe the perimeter region of the substrate surface, with a gap between opposed terminal ends of the seal material. For example, an uncured adhesive seal material, such as an uncured epoxy material or the like, may be applied to the surface of the substrate (such as, for example, the rear substrate of the mirror cell) along the perimeter region of the surface of the mirror shape or substrate, and the filter element or material or filtering means may be disposed at the gap between the terminal ends of the uncured epoxy material that circumscribes the substrate or mirror shape. The other substrate (such as, for example, the front cut shape or substrate) is superimposed upon the rear substrate and spaced therefrom by the applied uncured material (with spacing elements or beads disposed therein) and is mated with the first substrate to assemble the substrates together with the filter element at the fill port of the cell. The uncured adhesive material is then cured, such as by heating, to adhere the shapes or substrates together and to space the glass sheets or substrates apart a desired amount to define the appropriate interpane cavity or spacing. An electrolyte or monomer composition is then filled into the interpane cavity or cavities via the fill port provided in the perimeter material or seal (and through the filter element at the fill port), such as via a vacuum fill process. Optionally, aspects of the present invention may be suitable for application to other devices or cells with filled interpane cavities, such as, for example, display elements or devices (such as liquid crystal display (LCD) devices, or backlit thin film transistor (TFT) and/or the like.

As discussed above, the rearview mirror reflective element assembly of the present invention comprises an electro-optic or electrochromic reflective element assembly or cell, such as an electrochromic mirror reflective element assembly with coated substrates that are coated utilizing principles disclosed in commonly assigned U.S. Pat. Nos. 7,310,178; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,71.2,879, which are hereby incorporated herein by reference in their entireties, and/or as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated by reference herein in their entireties. Optionally, the electrochromic circuitry and/or a glare sensor (such as a rearward facing glare sensor that receives light from rearward of the mirror assembly and vehicle through a port or opening along the casing and/or bezel portion and/or reflective element of the mirror assembly) and circuitry and/or an ambient light sensor and circuitry may be provided on one or more circuit boards of the mirror assembly that receives or incorporates the mirror reflective element assembly or cell constructed in accordance with the present invention.

Although such transflective reflective element assemblies are capable of transmitting the illumination or display information through the assembly, it is sometimes desirable to provide a window in the metallic reflective coating through which the display information or illumination may be transmitted. Typically, such windows in the reflective coating of transflective reflective element assemblies are desirable for a glare sensor (such as a photo sensor or the like, such as a glare sensor and/or an ambient light sensor and electrochromic automatic dimming circuitry described in U.S. Pat. Nos. 4,793,690; 5,193,029; and/or 7,004,593, which are all hereby incorporated herein by reference in their entireties) or the like to be positioned at, in order to allow substantial transmission of light from the rear of the mirror assembly or vehicle through the reflective element assembly to the glare sensor positioned within the mirror assembly. The sensors may comprise glare sensors or photo sensors (such as sensors of the types described in U.S. Pat. Nos. 4,793,690; 5,193,029 and/or. 7,004,593, which are all hereby incorporated herein by reference in their entireties), or touch or proximity sensors (such as the sensors of the types described in U.S. Pat. No. 7,249,860, which is hereby incorporated herein by reference in its entirety).

Typically, the material for the substrates comprises glass, such as soda-lime glass or the like, but other materials, such as polycarbonate or other polymeric materials may be utilized without affecting the scope of the present invention. The completed mirror cells or reflective element assemblies include a front substrate and a rear substrate. The rear substrate may have a reflective coating on its front surface (toward the front substrate when the substrates are sandwiched together, and typically referred to as the third surface of the mirror reflective element assembly), while the front substrate may have a transparent semiconductive coating, such as a coating of indium tin oxide (ITO) or doped indium tin oxide or the like, on its rear surface (toward the rear substrate when the substrates are sandwiched together, and typically referred to as the second surface of the mirror reflective element assembly).

Although shown as having generally flush edges, the cells manufactured by the process of the present invention may have generally or substantially flush edges or offset edges or overhang regions or the like, while remaining within the spirit and scope of the present invention, such as the types of cells described in U.S. Pat. Nos. 7,274,501; 7,184,190 and/or 7,255,451, which are hereby incorporated herein by reference in their entireties, or may have other forms or shapes, such as the mirror shapes described in U.S. Pat. No. 7,110,156, and/or shown in U.S. Design Pat. Nos. D493,131 and/or D493,394, which are hereby incorporated herein by reference in their entireties.

The method of the present invention provides an enhanced assembly process for manufacturing an electrochromic mirror reflective element cell assembly, such as the type shown in FIGS. 1 and 2 and described above. The method or process may clean and coat individual cut glass shapes or a large sheet of glass (such as soda lime glass or other material, such as polycarbonate or the like) and adheres coated sheets of glass together (or adheres coated substrates to a sheet of multiple mirror shapes) before the shapes or substrates or cells are scribed and broken out or cut from the sheet or sheets, such as by utilizing aspects of the mirror assembly processes described in U.S. Pat. No. 7,255,451, which is hereby incorporated herein by reference in its entirety.

After the coating (and laser etching if applicable) processes, the glass sheet or substrate is conveyed or moved to a dispensing process or dispenser, where an uncured adhesive material, such as an epoxy seal material, may be dispensed onto the pristine coated and cleaned surface of the substrate. The sheet or substrate may be positioned at an appropriate location in response to a computer aided camera or vision or imaging system detecting the register marks and the conveyor or automated or computer controlled robot or robotic arm or the like positioning the sheet to align the register marks with a predetermined location. The fixturing and dispensing machine may find the register marks and may dispense the uncured seal material in the desired location and shape based on the marks. The uncured seal material (and spacer beads or the like, such as glass beads or the like, as is known in the mirror art) thus may be dispensed onto the sheet or substrate or mirror shape. The seal material, when cured, forms the cavity boundary for a plurality of cells or mirror shapes.

Optionally, while the seal material mirror shapes are dispensed or after the seal material mirror shapes are dispensed, a plurality of portions of adhesive, such as drops or spots or segments of a UV curable adhesive or the like, may be applied on the surface of the sheet (such as by an adhesive dispenser) at areas outside of the seal material mirror shapes. The portions may be dispensed or applied by the same dispensing machine or by another dispenser, without affecting the scope of the present invention. The UV curable adhesive portions may be quickly cured (after the substrates are mated together, as discussed below) via exposure to UV light or via heat to adhesively secure the sheets together, as described below. The UV curable adhesive may serve to hold the substrates together until the epoxy seals are cured.

For applications where the filter element is integral with the cell, the filter material or mesh element may be disposed at the dispensed perimeter seal and at the gap or fill port location prior to the mating of the substrates together. After the seal material (and optionally adhesive drops and the filter material) are dispensed onto or disposed at the surface of the sheet or substrate, the sheet or substrate is conveyed or moved to a coupling or mating station, where the front glass sheet or substrate is positioned at and placed onto the rear sheet or substrate, such as via an automated or computer controlled robot or robotic arm or the like. The front sheet or substrate may be processed in a similar manner as described above for the rear sheet or substrate, or may be supplied to the mirror manufacturer as pre-coated sheets or pre-coated and pre-cut substrates, without affecting the scope of the present invention. The front sheet or substrate is cleaned and washed prior to coupling the sheet or substrate with the rear sheet or substrate, so that the pristine surface of the front sheet or substrate is clean and free of debris and the like when the cell is assembled.

For example, the substrate surface of the front and/or rear substrates may be initially coated with a transparent electrically conductive coating, such as a low cost tin oxide coating or the like, such as the types described in U.S. Pat. Nos. 6,420,036; 6,245,262; 6,154,306; and 5,724,187, which are hereby incorporated herein by reference in their entireties. For example, a mirror assembly manufacturer may purchase tin oxide-coated glass substrates or sheets, such as sold by the LOF Glass division of Libbey-Owens-Ford Co., Toledo, Ohio under the trade name of “TEC-Glass” products, such as “TEC 10” (10 ohms per square sheet resistance), “TEC 12” (12 ohms per square sheet resistance), “TEC 15” (15 ohms per square sheet resistance) and “TEC 20” (20 ohms per square sheet resistance) tin oxide-coated glass and the like. Moreover, tin oxide coated glass substrates, such as commercially available from Pittsburgh Plate Glass Industries, Pittsburgh, Pa. under the “SUNGATE” trade name, may be advantageously employed herein.

The rear sheet or substrate may be positioned at an appropriate location (such as via the conveyor or an automated or computer controlled robot or robotic arm or the like) in response to identification/recognition (such as by a computer aided camera vision or imaging system) of register marks or the like formed in the coated surface or via identification/recognition of the edges of the cut and coated substrate. The front sheet or substrate (with the ITO layer or the like applied to its surface) may be supplied to the coupling station from the washer, such that the front sheet or substrate is cleaned just prior to the coupling of the sheets together. The clean front sheet or substrate is then positioned relative to the rear sheet or substrate and the epoxy seal (and optionally the integral or permanent filter element), and may be pressed into engagement with the epoxy seals and UV curable glue dots. The sheets or substrates may be positioned relative to one another in response to detection of the register marks on one or both sheets or substrates and/or by the detection of the edges or other characteristics or physical attributes of the front sheet or substrate, such as detection of flat portions or edges along the front shapes, such as by a computer aided camera vision or imaging system or the like. The automated robot may substantially uniformly press the sheets together, whereby the epoxy seal material (and spacing elements or beads) provides the appropriate spacing between the sheets or substrates and defines the cell cavity. The UV curable glue dots may be cured (such as by exposure to UV light and/or heat or other means for curing the quick curing adhesive) while the sheets or substrates are pressed and held together at the desired spacing (as provided by the spacer beads or the like in the epoxy seal), such that the sheets or substrates are held at the appropriate spacing. The assembled cell (with the filter element established at and held in place at the fill port via its overlap with the epoxy seal material at either or both sides of the fill port or gap) may then be conveyed to a checking station to check the seal width and interpane cavity spacing and plug opening or fill port of the mirror cell.

While the front shapes are pressed against the uncured seal material, a quick curing adhesive, such as UV curable adhesive or the like, may be applied in portions around or partially around or spaced around the perimeter of the shape and between the front shape and the rear shape (and outside the perimeter seal material), and may be quickly cured (such as by exposure to UV light following the application of the adhesive). The UV curable adhesive may be applied and cured to each shape separately as the shape is juxtaposed and superimposed on the respective seal material of the rear sheet, or may be applied and cured after the shape or substrate is juxtaposed and superimposed on the respective seal material shapes of the rear sheet or substrate. For example, the UV curable adhesive may be applied in spots or dots around the perimeter of a substrate, and a UV curing device may follow the adhesive dispenser or applicator and may emit UV light soon or substantially immediately after the dots are applied to cure the UV curable adhesive and, thus, adhere the respective shape or substrate to the rear shape or substrate. The sandwiched shapes may then be conveyed to the checking station to check the seal width and interpane cavity spacing and plug openings as described above.

The sandwich of substrates may then be moved to a curing oven or fixture, which cures the epoxy seal material in a known manner, such as heat curing at approximately 150 degrees C. or via other processes. After the seal material is cured, the empty cell may then be filled, such as with an electrolyte or monomer composition, and plugged at a filling station (such as a vacuum filling station) in a known manner (or the sandwich of shapes or cells may be filled as described below). Optionally, for applications with an external or removable filter element, the filter element may be taped or adhered or otherwise disposed at and retained at and over the fill port. For applications with filter elements disposed in the fluid composition that is to be filled into the cell cavity, the filter elements may be added or disposed in the fluid composition at any time prior to the filling process. The mirror cells (with either a permanent filter element disposed in the fill port opening or a removable filter element disposed at and over the fill port opening) may be loaded into the vacuum fill chamber and filled (such as via dipping the cells into an electrolyte or monomer composition or electrochromic medium or via depositing or shooting the electrolyte or monomer composition or electrochromic medium onto or at the fill opening of the vacuumed cell, and such as by utilizing aspects of the assemblies and systems described in U.S. Pat. No. 5,140,455, which is hereby incorporated herein by reference in its entirety), and then removed and conveyed to a plugging station, where an operator may remove the mirror cell, remove the filter element (for applications with an external filter element removably attached at the cell) or trim the filter element (for applications where the filter element is integral with the cell and may have a portion of the filter material protruding from the outer perimeter edge of the cell), clean the end of the cell (that was dipped into the electrolyte or monomer composition or electrochromic medium during the filling process) and plug the fill hole with a plug, such as a UV curable adhesive or glue or the like. Optionally, the gap of fill port may be plugged with a non-conductive seal or plug material, such as a UV curable or heat curable seal or plug material (such as described in U.S. Pat. Nos. 6,207,083; 5,724,187; 5,233,461; and 5,142,407, which are hereby incorporated herein by reference in their entireties), to substantially seal the cell. After the hole is plugged, the cell is conveyed through a UV curing area which may emit UV light or radiation or energy to cure the UV curable adhesive plug, and is then conveyed to a cleaning station, where the cell is cleaned.

Optionally, the clean cell may then receive an electrode clip, which may be glued to the cell with a UV curable adhesive at a gluing station, and then may be conveyed to a UV curing area to cure the UV curable adhesive to adhere the clip to the cell. Optionally, the cell may then be conveyed to a soldering station, where a wire harness may be soldered to the electrode clip at the soldering station in a known manner to complete the cell manufacturing. Optionally, a tab-out area and the electrode clips of the rear substrate may then be encapsulated via known means at a tab-out coating/curing station.

Although shown as being applied to reflective element assemblies for interior rearview mirror assemblies, the process of the present invention is equally suited for exterior reflective element assemblies, and for flat substrates or convex or curved substrates or the like. The fixturing and conveying processes are substantially the same for any of these applications and/or for different designs or shapes of interior or exterior applications, while the laser deletion (or masking) and seal dispensing may be reconfigured or adjusted to accommodate the different mirror shapes for the different applications.

Therefore, the present invention provides an enhanced filling process for use in manufacturing reflective element assemblies or cells. The filter material functions to block or limit or substantially preclude intrusion of debris or contaminants into the cell cavity during the filling process. The filter element may be integral with or permanently part of the mirror cell (and may be at least partially disposed between the substrates at the fill port) or the filter element may be removably attached to the cell and removed after the filling process and prior to the plugging process.

The mounting assembly of the mirror assembly attached to an interior portion of the vehicle, such as to an inner surface of a vehicle windshield (such as to a mounting button or attachment element adhered to the interior surface of the vehicle windshield). The mirror assembly may be mounted at or attached to an interior portion of the vehicle (such as to a mounting button or the like at an interior surface of the vehicle windshield or the like) via any mounting means, such as a single ball or single pivot mounting arrangement, or a double ball or double pivot mirror mounting arrangement. Examples of double pivot or double ball mounting arrangements are described in commonly assigned U.S. Pat. Nos. 4,646,210 and 6,331,066, which are hereby incorporated herein by reference in their entireties. The mounting assembly may be mounted to a mounting button or attachment element at the vehicle windshield via a breakaway mounting construction, such as by utilizing aspects of the mounting constructions described in U.S. Pat. Nos. 6,774,810; 6,642,851; 6,483,438; 6,366,213; 6,326,900; 6,222,460; 6,172,613; 6,087,953; 5,820,097; 5,377,949; 5,330,149 and/or 5,100,095, which are hereby incorporated herein by reference in their entireties. The mounting assembly may utilize aspects of the mounting assemblies described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 (Attorney Docket DON01 P-1236), and/or U.S. provisional applications, Ser. No. 61/232,201, filed Aug. 7, 2009; Ser. No. 61/162,420, filed Mar. 23, 2009; and/or Ser. No. 61/255,192, filed Oct. 27, 2009, which are hereby incorporated herein by reference in their entireties). Optionally, the mirror assembly may incorporate a mounting arrangement of the types described in U.S. Pat. Nos. 7,289,037; 7,249,860; and/or 7,448,589, and/or U.S. patent application Ser. No, 10/522,446, filed Jan. 19, 2005 and published Nov. 10, 2005 as U.S. Patent Publication No. 2005-0248168, which are hereby incorporated herein by reference in their entireties.

Optionally, the mirror assembly may include one or more displays, such as the types disclosed in U.S. Pat. Nos. 5,530,240 and/or 6,329,925, which are hereby incorporated herein by reference in their entireties, and/or display-on-demand transflective type displays, such as the types disclosed in U.S. Pat. Nos. 7,626,749; 7,581,859; 7,338,177; 7,274,501; 7,255,451; 7,195,381; 7,184,190; 5,668,663; 5,724,187 and/or 6,690,268, and/or in U.S. patent applications, Ser. No. 12/091,525, filed Apr. 25, 2008 (Attorney Docket DON01 P-1300); 11/226,628, filed Sep. 14, 2005 (Attorney Docket DON01 P-1236); and/or Ser. No. 10/538,724, filed Jun. 13, 2005 (Attorney Docket DON01 P-1123), which are all hereby incorporated herein by reference in their entireties, so that the displays are viewable through the reflective element, while the display area still functions to substantially reflect light, in order to provide a generally uniform prismatic reflective element even in the areas that have display elements positioned behind the reflective element. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates, such as on the third surface of the reflective element assembly, may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties. Such display devices may transmit the display information or illumination through a transflective, third surface reflective element assembly, such as described in U.S. Pat. Nos. 5,668,663; 5,724,187; 6,690,268; 7,195,381; 7,184,190; 7,255,451; and/or 7,274,501, which are all hereby incorporated herein by reference in their entireties.

Optionally, a display and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 (Attorney Docket DON01 P-1123), which are hereby incorporated herein by reference in their entireties.

The display may comprise a video display and may utilize aspects of the video display devices or modules described in U.S. Pat, Nos. 6,690,268; 7,184,190; 7,274,501; 7,370,983; and/or 7,446,650, and/or U.S. patent applications, Ser. No. 12/091,525, filed Apr. 25, 2008 (Attorney Docket DON01 P-1300); and/or Ser. No. 10/538,724, filed Jun. 13, 2005 (Attorney Docket DON01 P-1123), which are all hereby incorporated herein by reference in their entireties. The video display may be operable to display images captured by one or more imaging sensors or cameras at the vehicle. The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,123,168; 7,004,606; 6,946,978; 7,038,577; 6,353,392; 6,320,176; 6,313,454; and 6,824,281, which are all hereby incorporated herein by reference in their entireties. The camera or camera module may comprise any suitable camera or imaging sensor, and may utilize aspects of the cameras or sensors described in U.S. patent applications, Ser. No. 12/091,359, filed Apr. 24, 2008 (Attorney Docket MAGO4 P-1299); and/or Ser. No. 10/534,632, filed May 11, 2005 and published Aug. 3, 2006 as U.S. Patent Publication No. US-2006-0171704A1 (Attorney Docket DON01 P-1118); and/or U.S. Pat. No. 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; and 7,004,606; and/or U.S. patent application Ser. No. 11/315,675, filed Dec. 22, 2005 and published Aug. 17, 2006 as U.S. Patent Publication No. US-2006-0184297A1 (Attorney Docket MAG04 P-1253), and/or U.S. patent application Ser. No. 10/534,632, filed May 11, 2005 and published Aug. 3, 2006 as U.S. Patent Publication No. US-2006-0171704A1 (Attorney Docket DON01 P-1118); and/or PCT Application No. PCT/US2008/076022, filed Sep. 11, 2008 and published Mar. 19, 2009 as International Publication No. WO/2009/036176, and/or PCT Application No. PCT/US2008/078700, filed Oct. 3, 2008 and published Apr. 9, 2009 as International Publication No. WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; and 7,339,149, and U.S. patent application Ser. No. 11/105,757, filed Apr. 14, 2005, now U.S. Pat. No. 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; and 6,946,978, and/or in U.S. pat. application Ser. No. 10/643,602, filed Aug. 19, 2003 (Attorney Docket MAGO4 P-1087), which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,038,577; 5,929,786 and/or 5,786,772, and/or U.S. pat. applications, Ser. No. 11/239,980, filed Sep. 30, 2005 (Attorney Docket MAGO4 P-1238); and/or Ser. No. 11/315,675, filed Dec. 22, 2005 (Attorney Docket MAGO4 P-1253), and/or U.S. provisional applications, Ser. No. 60/628,709, filed Nov. 17, 2004; Ser. No. 60/614,644, filed Sep. 30, 2004; Set No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018-A1 (Attorney Docket DON01 P-1123), which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent applications, Ser. No. 11/226,628, filed Sep. 14, 2005 (Attorney Docket DON01 P-1236), and/or Ser. No. 12/578,732, filed Oct. 14, 2009 (Attorney Docket DON01 P-1564), which are hereby incorporated herein by reference in their entireties.

Optionally, the mirror assembly may include a compass system and compass circuitry, such as a compass system utilizing aspects of the compass systems described in U.S. Pat. Nos. 7,289,037; 7,249,860; 7,004,593; 6,642,851; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and/or 6,513,252, and/or European patent application, published Oct. 11, 2000 under Publication No. EP 0 1043566, which are all hereby incorporated herein by reference in their entireties. The compass circuitry may include compass sensors, such as a magneto-responsive sensor, such as a magneto-resistive sensor, a magneto-capacitive sensor, a Hall sensor, a magneto-inductive sensor, a flux-gate sensor or the like. The sensor or sensors may be positioned at and within a base portion of the mirror assembly so that the sensor/sensors is/are substantially fixedly positioned within the vehicle, or may be attached or positioned within the mirror casing. Note that the magneto-responsive sensor used with the mirror assembly may comprise a magneto-responsive sensor, such as a magneto-resistive sensor, such as the types disclosed in U.S. Pat. Nos. 5,255,442; 5,632,092; 5,802,727; 6,173,501; 6,427,349; and/or 6,513,252 (which are hereby incorporated herein by reference in their entireties), or a magneto-inductive sensor, such as described in U.S. Pat. No. 5,878,370 (which is hereby incorporated herein by reference in its entirety), or a magneto-impedance sensor, such as the types described in PCT Publication No. WO 2004/076971, published Sep. 10, 2004 (which is hereby incorporated herein by reference in its entirety), or a Hall-effect sensor, such as the types described in U.S. Pat. Nos. 6,278,271; 5,942,895 and/or 6,184,679 (which are hereby incorporated herein by reference in its entirety). The sensor circuitry and/or the circuitry in the mirror housing and associated with the sensor may include processing circuitry. For example, a printed circuit board may include processing circuitry which may include compensation methods, such as those described in U.S. Pat. Nos. 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and 6,642,851, which are all hereby incorporated herein by reference in their entireties. The compass sensor may be incorporated in or associated with a compass system and/or display system for displaying a directional heading of the vehicle to the driver, such as a compass system of the types described in U.S. Pat. Nos. 5,924,212; 4,862,594; 4,937,945; 5,131,154; 5,255,442; 5,632,092; 7,289,037 and/or 7,004,593, which are all hereby incorporated herein by reference in their entireties.

Optionally, the mirror assembly may include user inputs that may comprise buttons or switches for controlling or activating/deactivating one or more electrical accessories or devices of or associated with the mirror assembly. The mirror assembly may comprise any type of switches or buttons, such as touch or proximity sensing switches, such as touch or proximity switches of the types described above, or the inputs may comprise other types of buttons or switches, such as those described in U.S. Pat. Nos. 6,001,486; 6,310,611; 6,320,282; 6,627,918; 6,690,268; 7,224,324; 7,249,860; 7,253,723; 7,255,451; 7,360,932; and/or 7,446,924, and/or U.S. patent applications, Ser. No. 10/538,724, filed Jun. 13, 2005 (Attorney Docket DON01 P-1123), and/or Ser. No. 12/576,550, filed Oct. 12, 2009 (Attorney Docket DON01 P-1562), which are all hereby incorporated herein by reference in their entireties, or such as fabric-made position detectors, such as those described in U.S. Pat. Nos. 6,504,531; 6,501,465; 6,492,980; 6,452,479; 6,437,258; and 6,369,804, which are hereby incorporated herein by reference in their entireties.

Optionally, the user inputs or buttons may comprise user inputs for a garage door opening system, such as a vehicle based garage door opening system of the types described in U.S. Pat. Nos. 6,396,408; 6,362,771; 7,023,322; and 5,798,688, which are hereby incorporated herein by reference in their entireties. The user inputs may also or otherwise function to activate and deactivate a display or function or accessory, and/or may activate/deactivate and/or commence a calibration of a compass system of the mirror assembly and/or vehicle. The compass system may include compass sensors and circuitry within the mirror assembly or within a compass pod or module at or near or associated with the mirror assembly. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; and/or 6,678,614, and/or U.S. pat. application Ser. No, 10/538,724, filed Jun. 13, 2005 (Attorney Docket DON01 P-1123), and/or U.S. patent application Ser. No. 10/529,715, filed Mar. 30, 2005, now U.S. Pat. No. 7,657,052, which are all hereby incorporated herein by reference in their entireties.

Optionally, the mirror assembly may include one or more other accessories at or within the mirror casing or otherwise associated with or near the mirror assembly, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093 and/or U.S. provisional application Ser. No. 61/785,565, filed May 15, 2009, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775; and/or 7,249,860, microphones, such as disclosed in U.S. Pat. Nos. 6,243,003; 6,278,377; and/or 6,420,975; and/or U.S. patent application Ser. No. 10/529,715, filed Mar. 30, 2005, now U.S. Pat. No. 7,657,052, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot or object detection system, such as disclosed in U.S. Pat. Nos. 5,929,786; 5,786,772; 7,492,281; 7,038,577 and 6,882,287; and/or U.S. patent applications, Ser. No. 11/315,675, filed Dec. 22, 2005 (Attorney Docket DON01 P-1253); and/or Ser. No. 12/446,507, filed Apr. 21, 2009 (Attorney Docket DON09 P-1382), transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, and/or U.S. provisional application Ser. No. 61/785,565, filed May 15, 2009, a memory mirror system, such as disclosed in U.S. Pat. No, 5,796,176, a hands-free phone attachment, an imaging system or components or circuitry or display thereof, such as an imaging and/or display system of the types described in U.S. Pat. Nos. 7,400,435; 6,690,268 and 6,847,487, and/or U.S. patent applications, Ser. No. 11/239,980, filed Sep. 30, 2005 (Attorney Docket DON01 P-1238); Ser. No. 11/105,757, filed Apr. 14, 2005, now U.S. Pat. No. 7,526,103; Ser. No. 12/578,732, filed Oct. 14, 2009 (Attorney Docket DON01 P-1564); and/or Ser. No. 12/508,840, filed Jul. 24, 2009 (Attorney Docket MAGO4 P-1541), an alert system, such as an alert system of the types described in PCT Application No. PCT/US2010/25545, filed Feb. 26, 2010, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205; and/or 7,423,522, and/or U.S. provisional application, Ser. No. 60/611,796, filed Sep. 21, 2004), and/or an ONSTAR® system, a compass, such as disclosed in U.S. Pat. Nos. 5,924,212; 4,862,594; 4,937,945; 5,131,154; 5,255,442; and/or 5,632,092, a control system, such as a control system of the types described in U.S. provisional application Ser. No. 61/186,573, filed Jun. 12, 2009, and/or any other accessory or circuitry or the like (with the disclosures of the above-referenced patents and patent applications and provisional applications and PCT applications being hereby incorporated herein by reference in their entireties).

The accessory or accessories may be positioned at or within the mirror casing and may be included on or integrated in the printed circuit board positioned within the mirror casing, such as along a rear surface of the reflective element or elsewhere within a cavity defined by the casing, without affecting the scope of the present invention. The user actuatable inputs described above may be actuatable to control and/or adjust the accessories of the mirror assembly/system and/or an overhead console and/or an accessory module/windshield electronics module and/or the vehicle. The connection or link between the controls and the systems or accessories may be provided via vehicle electronic or communication systems and the like, and may be connected via various protocols or nodes, such as BLUETOOTH®, SCP, UBP, J1850, CAN J2284, Fire Wire 1394, MOST, LIN, FLEXRAY™, Byte Flight and/or the like, or other vehicle-based or in-vehicle communication links or systems (such as WIFI and/or IRDA) and/or the like, depending on the particular application of the mirror/accessory system and the vehicle. Optionally, the connections or links may be provided via wireless connectivity or links, such as via a wireless communication network or system, such as described in U.S. Pat. No. 7,004,593, which is hereby incorporated herein by reference in its entirety, without affecting the scope of the present invention.

Optionally, a reflective element assembly of the present invention (such as for an interior or exterior rearview mirror assembly) may include a photo sensor or light sensor (such as the types described in U.S. Pat. Nos. 6,831,268; 6,742,904; 6,737,629; 5,406,414; 5,253,109; 4,799,768; 4,793,690; and/or 7,004,593, which are hereby incorporated herein by reference in their entireties) at the rear or fourth surface of the reflective element assembly, such that the photo sensor detects light passing through the reflective element assembly. Examples of such configurations are described in U.S. Pat. Nos. 4,793,690; 5,550,677; 5,193,029 and/or 7,004,593, which are all hereby incorporated herein by reference in their entireties. The reflective element assembly thus may have a window or transmissive port or portion at the photo sensor or, and preferably, may comprise a transflective display on demand (DOD) type reflective element assembly or cell, such as, for example, the types described in. U.S. Pat. Nos. 5,668,663; 5,724,187; 6,690,268; 7,195,381; 7,274,501; 7,255,451 and/or 7,184,190, which are all hereby incorporated herein by reference in their entireties. The transflective reflective element assembly may have a fixed attenuation such that only a relatively small amount of light passes therethrough, such as about 12 to 25 percent of the light incident on the reflective element assembly, such that the signal to dark current ratio generated at the sensor may be substantially reduced. Because the photo sensor may have a relatively small sensing area, the sensor may not receive or sense a substantial amount of light passing through the reflective element assembly. Therefore, it is envisioned that a light concentrator (such as a lens and/or light channel and/or light pipe and/or other light concentrating device) may be positioned at the photo sensor to focus or direct the light passing through a larger area of the reflective element assembly onto the smaller sensing area of the photo sensor.

Note that electrochromic mirror cells or reflective element assemblies made such as by any of the processes of the present invention can be included in complete mirror assemblies that include a variety of added-features, such as lighting, telematics functionality and electronics, such as are disclosed in U.S. Pat. Nos. 7,657,052; 7,308,341; 7,195,381; 7,167,796; 7,004,593; 6,690,268; 6,477,464; 6,472,979; 6,445,287; 6,420,975; 6,294,989; 6,278,377; 6,243,003; 6,042,253; 5,938,321; 5,924,212; 5,813,745; 5,820,245; 5,669,698; 5,673,994; 5,671,996; 5,649,756; 5,632,092; 5,255,442; 5,178,448; 5,131,154; 4,937,945; 4,862,594; 4,807,096; 4,733,336; and/or 4,646,210, which are all hereby incorporated herein by reference in their entireties.

Changes and modifications in the specifically described embodiments may be carried out without departing from the principles of the present invention, which is intended to be limited only by the scope of the appended claims, as interpreted according to the principles of patent law.

What is claimed is:

1. A variable reflectance vehicular electro-optic rearview mirror reflective element assembly comprising:
a front substrate having a first surface that generally faces a driver of a vehicle equipped with a mirror assembly that incorporates said rearview mirror reflective element assembly;
said front substrate having a second surface opposite said first surface, wherein said second surface of said front substrate has a transparent electrically conductive coating disposed thereat;
a rear substrate having a third surface and a fourth surface, wherein said third surface has a conductive coating disposed thereat;
a perimeter seal disposed between said front and rear substrates, said perimeter seal spacing said front and rear substrates apart and forming an interpane cavity therebetween, wherein said perimeter seal has a gap between terminal ends of said perimeter seal to provide a fill port for said mirror reflective element assembly when said front and rear substrates are mated together; and
a filter element disposed at said fill port at least during a cavity filling process, said filter element allowing an electro-optic medium to flow therethrough during the cavity filling process and limiting passage of contaminant particles to limit intrusion of contaminant particles into said interpane cavity during the cavity filling process.

2. The mirror reflective element assembly of claim 1, wherein said filter element comprises a mesh material.

3. The mirror reflective element assembly of claim 1, wherein said filter element is disposed at said gap and between said perimeter seal and one of said front and rear substrates.

4. The mirror reflective element assembly of claim 1, wherein said filter element is removably attached at or near said fill port and is removed after the cavity filling process.

5. A method of manufacturing a variable reflectance vehicular electro-optic rearview mirror reflective element assembly, said method comprising:
providing a front substrate having a first surface that generally faces a driver of a vehicle equipped with a mirror assembly that incorporates said rearview mirror reflective element assembly, wherein said front substrate has a second surface opposite said first surface and wherein said second surface of said front substrate has a transparent electrically conductive coating disposed thereat;
providing a rear substrate having a third surface and a fourth surface, wherein said third surface has a conductive coating disposed thereat;
dispensing a perimeter seal at a perimeter edge region of one of said front and rear substrates, wherein said perimeter seal has a gap between terminal ends of said perimeter seal;
mating said front and rear substrates together, whereby said perimeter seal spaces said front and rear substrates apart and forms an interpane cavity therebetween, wherein said gap between said terminal ends of said perimeter seal provides a fill port for said mirror reflective element assembly when said front and rear substrates are mated together;
providing a filter element at said fill port;
filling said interpane cavity with an electro-optic medium that flows into said interpane cavity through said fill port and through said filter element, said filter element allowing said electro-optic medium to flow therethrough during said cavity filling process and limiting passage of contaminant particles to limit intrusion of contaminant particles into said interpane cavity during said cavity filling process; and
plugging said fill port to substantially seal said electro-optic medium in said interpane cavity.

6. The method of claim 5, wherein providing a filter element comprises providing a filter element at said fill port before mating said front and rear substrates together, whereby said filter element is disposed at said gap and between said perimeter seal and one of said front and rear substrates.

7. The method of claim 5, wherein providing a filter element comprises providing a filter element at said fill port after mating said front and rear substrates together.

8. The method of claim 7, wherein said filter element is removably attached at said substrates and at least partially over said fill port.

9. The method of claim 8, wherein said filter element is adhered at said substrates and at least partially over said fill port.

10. The method of claim 7, further comprising removing said filter element after said cavity filling process and before plugging said fill port.

11. The method of claim 5, wherein providing a filter element comprises providing a plurality of filter elements in said electro-optic medium, and wherein said filter elements have a cross dimension that is larger than an interpane gap dimension at said fill port, and wherein said filter elements do not ingress into said interpane cavity during said cavity filling process.

12. The method of claim 11, wherein said filter elements comprise balls that have a diameter that is greater than said interpane gap dimension.

13. The method of claim 5, wherein said filter element comprises a mesh material.
